(19) United States
(12) Patent Application Publication
(10) Pub. No.: US 2004/0080554 A1
(43) Pub. Date: Apr. 29, 2004

(54) Device for and method of transmitting serial data/addresses for a printer head and a printer

(75) Inventor: Kyu-Sung Kim, Yongin-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/685,508

(22) Filed: Oct. 16, 2003

(30) Foreign Application Priority Data
Oct. 22, 2002 (KR) 2002-64589

(51) Int. Cl. B41J 29/38

(52) U.S. Cl. 347/12

(57) ABSTRACT

A device for and a method of transmitting serial data and/or addresses to a printer head. A data processing unit provides serial input data for determining nozzles to be fired simultaneously and data for controlling a nozzle group firing order. The serial data is converted to parallel data and bits for determining the simultaneous firing nozzles are separated from a bit which determines the nozzle group firing order. A bi-directional shift register has parallel outputs which are changed by shifting a preset value left or right based on a latch clock and the firing order bit. The converted parallel input data and the outputs of the bi-directional shift register are logic ANDed to output nozzle firing signals. Logic operations in the printer head are simplified, a number of connections is reduced, and interface signals between the printer head and the printer main body are minimized.

### CROSS REFERENCE TO RELATED APPLICATIONS

This application claims the benefit of Korean Patent Application No. 2002-64589, filed Oct. 22, 2002, in the Korean Intellectual Property Office, the disclosure of which is incorporated herein by reference.

### BACKGROUND OF THE INVENTION

1. Field of the Invention

The present invention relates to an inkjet printer, and more particularly, to a device for and method of transmitting serial data and/or addresses for a printer head and a printer.

2. Description of the Related Art

FIG. 1 is a view for showing a device for driving a conventional printer head, which is disclosed in U.S. Pat. No. 6,312,079.

As shown in FIG. 1, the conventional printer has a group data line 4 for selecting a nozzle group, a primitive data line 20 for selecting nozzles to be fired at the same time, a clock 1 line 18 for shifting the group data and the primitive data in a shift latch, and an interface signal for a fire pulse 38. Further, the conventional printer has first memories 6 for storing serial group selection data and second memories 22 for storing serial primitive data, and additionally has a decoder 30 for decoding the serial group data and AND gates 36 for carrying out AND-operations with first memory data 52 and second memory data 54. Further, a clock 2 (44) is included to latch the outputs of the AND gates 36 to a fire pulse latch 32.

The output of the fire pulse latch 32 is logic-ANDed with the fire pulse 38 through an AND gate 40, and the output of the AND gate 40 is applied to the gate of a driving FET(not shown) for each head nozzle. Such a conventional printer as structured above selects a nozzle group through the group data line 4, and stores firing data in the first memories 6 and the second memories 22 through the primitive data line 20 in synchronization with the clock 1 18. The serial nozzle group selection data stored in the first memories 6 selects one nozzle group through the decoder 30. Further, the firing data stored in the second memories 22 is ANDed with the nozzle group selection data and then latched in synchronization with a signal of clock 2 44. Such latched data is ANDed with the fire pulse 38 again, and transmitted to the gate of the driving FET for each nozzle. Accordingly, only the nozzles in nozzle groups selected from the nozzles of a printer head are fired.

However, the conventional printer has the connections of the serial group data lines in addition to the serial primitive data lines so as to have plural interface signals. Accordingly, the conventional printer has the complicated connections between the printer head and the printer, which increases error factors during the manufacture of printer heads or during printing. Further, there exist as many fire pulse latches 32 latching firing data and AND gates 36 as the nozzles of the printer head, which causes a problem of increasing logic operations in the printer head.

### SUMMARY OF THE INVENTION

Accordingly, it is an aspect of the present invention to minimize interface signals between a printer head and a printer to simplify connection of the printer and the printer head.

It is another aspect of the present invention to simplify logic operations in the printer head to minimize a printer head logic unit.

According to an aspect of the present invention, a method of transmitting serial data/addresses for a printer head comprises generating and supplying data for determining simultaneous firing nozzles and a nozzle group firing direction through a fire/group direction data line; latching the data supplied through the fire/group direction data line to first memories in synchronization with a shift clock; storing data for determining the simultaneous firing nozzles in second memories in synchronization with the latched outputs of the first memories and a latch clock; outputting signals for selecting nozzle groups from a bi-directional shift register in synchronization with the latch clock provided from the latch clock line, ANDing the simultaneous firing nozzle data outputted from the second memories in synchronization with a fire pulse to generate the simultaneous firing data; and ANDing the stored data for determining simultaneous firing pulses and the nozzle group selection signals of the bi-directional shift register to apply driving signals to the gates of FETs driving nozzles so that selected nozzles are fired.

According to an aspect of the present invention, a device for transmitting serial data/addresses for a printer head comprises a data processing unit which provides simultaneous firing nozzle data, data for determining a nozzle group firing direction, and a fire pulse; a firing group direction data linewhich provides the data for determining the simultaneous firing nozzles and the nozzle group firing direction to the printer head; a fire pulse line which provides the fire pulse to the printer head; a first selection unit which selects the simultaneous firing nozzles based on the fire/group firing direction data; a second unit which selects specific firing nozzles through the first selection unit based on the fire pulse; a bi-directional shift register which generates firing nozzle group selection signals; and a firing unit which fires the specific nozzles selected based on the firing nozzle group selection signals.

The device may further comprise first memories which store the simultaneous firing nozzle data and the nozzle group firing direction data, wherein a number of the first memories is one more in number than a number of the simultaneous firing nozzles.

The device may further comprise second memories which store the simultaneous firing nozzle data, wherein a number of the second memories equals the number of the simultaneous firing nozzles.

The device may further comprise as many logic AND gates which logic-AND the simultaneous firing nozzle data and the fire pulse signal as the number of the simultaneous firing nozzles, and may further comprise as many logic AND gates which logic-AND the outputs of the first logic AND unit and the nozzle group selection signals of the bi-directional shift register as a number of the nozzles of the printer head.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of the preferred embodiments taken in conjunction with the accompanying drawings in which: The invention will be described in detail with reference to the following drawings in which like reference numerals refer to like elements, and wherein:

FIG. 1 is a view for schematically showing a conventional device for driving a printer head;

FIG. 2A is a view for schematically showing a portion of an apparatus for serial data/address transmission device according to the present invention;

FIG. 2B is a view for schematically showing another portion of the apparatus for serial data/address transmission according to the present invention;

FIG. 3 is a table for illustrating logic operations of the portion of the apparatus shown in FIG. 2B; and

FIG. 4 is a flow chart for explaining an operation of the apparatus shown in FIGS. 2A and 2B.

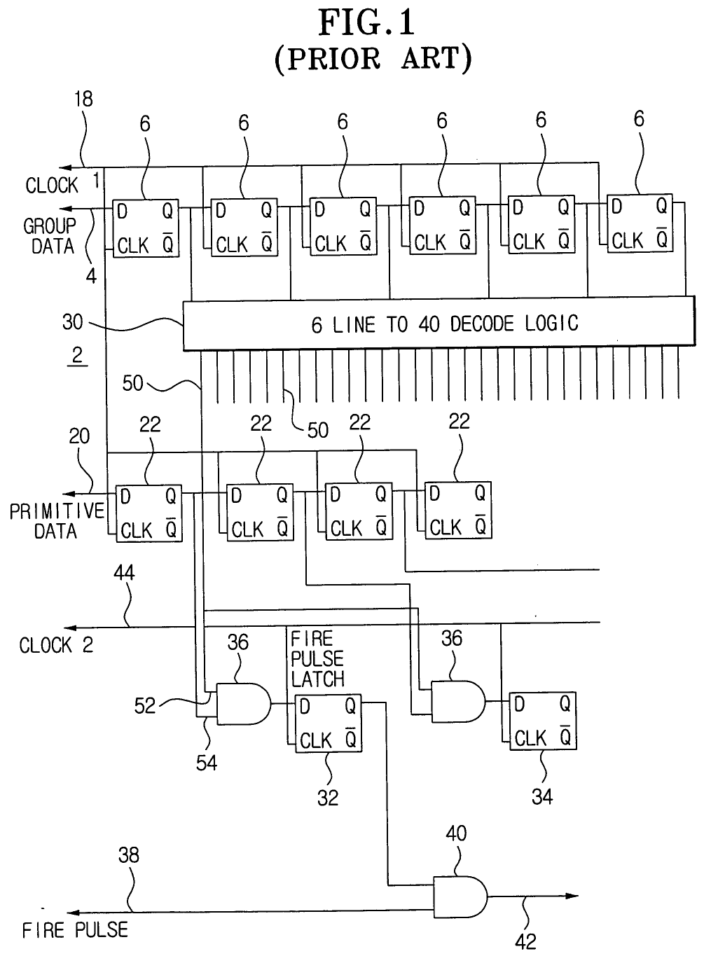

### DESCRIPTION OF THE PREFERRED EMBODIMENT

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

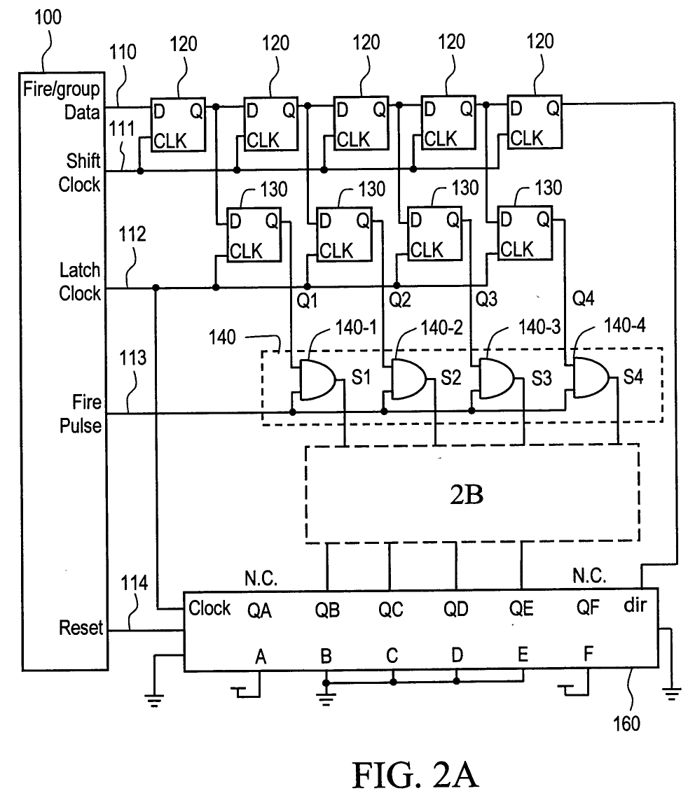

FIGS. 2A and 2B are block diagrams for schematically showing a serial data/address transmission device for a printer head according to an embodiment of the present invention. As shown in FIGS. 2A and 2B, the serial data/address transmission device comprises a data processor 100, a plurality of first memories 120, a plurality of second memories 130, a first logic AND unit 140, a second logic AND unit 150, and a bi-directional shift register 160. The data processor 100 provides input data to the printer head. The input data provided comprises data for nozzles to be fired at the same time and data for determining a firing order of nozzle groups to be fired (nozzle group direction data) through a fire/group direction data line 110. Further, a fire pulse to determine a final fire is provided to the printer head through the fire pulse line 113. A shift clock to latch data is provided to the printer head through a shift clock line 111 in order to store the input data in the first memories 120, and a latch clock for latching nozzle group data is provided to the printer head through the latch clock line 112.

The first memories 120 store the input data which are sequentially latched by the shift clock 111. A number of the first memories 120 is one more than a number of the simultaneous firing nozzles (the invention is illustrated with an embodiment comprising four nozzles) in order to provide the direction data of a firing group to a port (dir) of the bi-directional shift register 160.

If the firing direction data and the firing nozzle data are all latched to the first memories 120, the second memories 130 latch the firing nozzle data, synchronizing the outputs (Q) of the first memories 120 with the latch clock of the latch clock line 112, and determine and output simultaneous firing nozzle signals, Q1, Q2, Q3, Q4. Further, a number of the second memories 130 is the same as the number of the simultaneous firing nozzles.

The first logic AND unit 140 ANDs the firing nozzle signals Q1, Q2, Q3, Q4 output from of the second memories 130 and the fire pulse to determine final firing signals S1, S2, S3 and S4 to fire the simultaneous firing nozzles. A number of individual AND gates (140-1, 140-2, 140-3, 140-4) required in the first logic AND unit 140 is the same as the number of the simultaneous firing nozzles.

In the meantime, the bi-directional shift register 160 outputs signals except for the MSB and the LSB in order to choose nozzle groups (for example, four groups in the embodiment) from the outputs of the nozzle group selection signals QB, QC, QD and QE. The bi-directional shift register 160 is loaded with data having an MSB of “1” and an LSB of “1” and the loading is performed in every slice, and the data is shifted in synchronization with the latch clock of the latch clock line 112. With the shift operations according to the latch clock of the latch clock line 112, the nozzle group selection data is output to the second AND unit 150 with the generation of a signal selecting only one nozzle group from the nozzle groups QB - QE. The shift direction is determined with reference to the nozzle group direction data provided to the port “dir” out of the data latched through the fire/group direction data line 110.

The second AND unit 150 ANDs the firing nozzle group selection signals (QB, QC, QD, QE) output from the bi-directional shift register 160 and the outputs (S1, S2, S3, S4) of the first logic AND unit 140, and determine and outputs simultaneous firing nozzle signals for a selected nozzle group so that the selected nozzle signals are connected to respective gates of corresponding FETs be fired (B1-B4, C1-C4, D1-D4, E1-E4).

Referring now to FIG. 2B, the output S1 of the first logic AND unit 140 is simultaneously connected to respective first inputs of AND gates 150B1, 150C1, 150D1, and 150E1 of the second AND unit 150. Similarly, the output S2 of the first logic AND unit 140 is simultaneously connected to respective first inputs of AND gates 150B2, 150C2, 150D2 and 150E2 of the second AND unit 150; the output S3 of the first logic AND unit 140 is simultaneously connected to respective first inputs of AND gates 150B3, 150C3, 150E3; and the output S4 of the first logic AND unit 140 is simultaneously connected to respective first inputs of AND gates 150B4, 150C4, 150D4 and 150E4.

The output QB of the bi-directional shift register 160 is simultaneously connected to respective second inputs of AND gates 150B1, 150B2, 150B3 and 150B4; the output QC of the bi-directional shift register 160 is simultaneously connected to respective second inputs of AND gates 150C1, 150C2, 150C3, 150C4; the output QD of the bi-directional shift register 160 is simultaneously connected to respective second inputs of AND gates 150D1, 150D2, 150D3, 150D4; and the output QE of the bi-directional shift register 160 is simultaneously connected to respective second inputs of AND gates 150E1, 150E2, 150E3, 150E4

Accordingly, for example, in order for the first and the second nozzles of nozzle group QC to be fired simultaneously, the first logic AND unit outputs a “1” at S1 and S2, the selection signal QC is output as “1” from the bi-directional shift register 160, and the second logic AND unit outputs a “1” at the outputs of AND gates 150C1 and 150C2. The first logic AND unit 140 is provided with as many AND gates as the groups of head nozzles, and the groups of head nozzles are connected to the nozzle group selection signals QB to QE of the bi-directional shift register 160 respectively via the second AND unit 150.

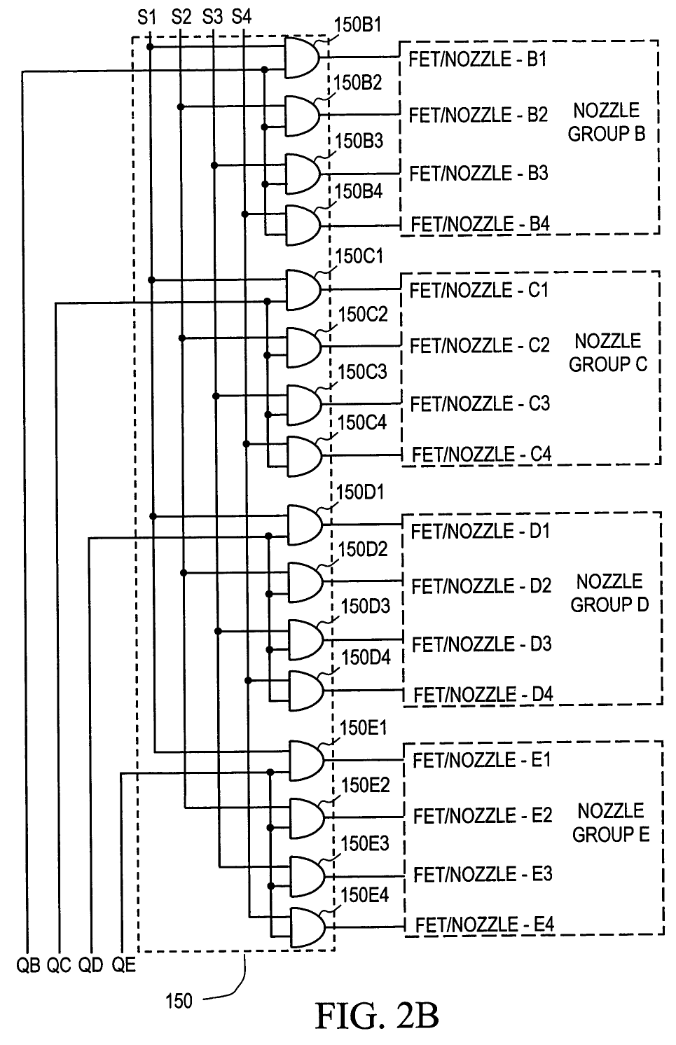

The nozzle groups are selected in an order B C D E or E D C B according to the signal dir output from the first memories 120. A summary of the logic operations of the second AND unit 150 is shown in FIG. 3.

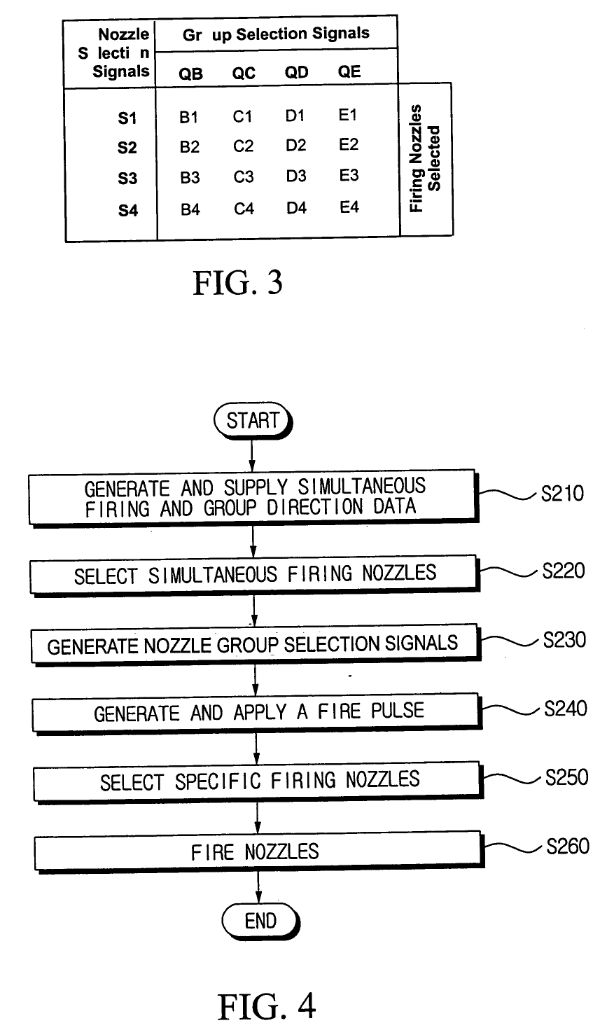

FIG. 4 is a flow chart for explaining a method for transmitting serial data/addresses for a printer head according to an embodiment of the present invention.

As shown in FIG. 4, the data processor 100 generates and supplies data determining simultaneous firing nozzles and a nozzle group firing direction (S210). The simultaneous firing nozzles are selected based on the data provided through the fire/group direction data line 110. The data provided through the fire/group direction data line 110 to the first memories 120 are latched at operation 220 in synchronization with the shift clock 111 generated from the data processor 100. Data for firing the simultaneous firing nozzles are stored in the second memories 130 in synchronization with the output of the first memories 120 and the latch clock provided through the latch clock line 112 of the data processor 100. The bi-directional shift register 160 outputs signals selecting nozzle groups(for example, four groups in the embodiment) from the outputs of the nozzle group selection signals QA to QF as the inputs of the second AND unit 150 in synchronization with a latch clock provided from the latch clock line 112 at operation 230. Meanwhile, a generated fire pulse signal is supplied through the fire pulse line 113 at operation S240. The simultaneous firing nozzle data outputted from the second memories 130 is ANDed in the first logic AND unit 140 in synchronization with the fire pulse line 113 provided from the data processor 100 so that the simultaneous firing nozzles are selected at operation S250. Accordingly, the second AND unit 150 ANDs the outputs of the first logic AND unit 140 and the nozzle group selection signals (QB-QE) of the bi-directional shift register 160. Each output of the second AND unit 150 is applied to a gate of an FET driving a respective nozzle so that the selected nozzle is fired at operation S260. Further, printing is completed with the repetitive performance of operations S210 through S260.

As stated above, the present invention simplifies the connections with the minimized interface signals between the printer head and the printer main body to prevent malfunctions, and simplifies logic operations in the printer head to minimize the size of the logic unit for the printer head.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of transmitting serial data/addresses for a printer head, comprising:
generating and supplying data for determining simultaneous firing nozzles and a nozzle group firing direction through a fire/group direction data line;
selecting simultaneous firing nozzles based on the data provided through the fire/group direction data line;
generating nozzle group selection signals from a bi-directional shift register to select nozzle groups;
generating and providing a fire pulse to fire the selected nozzles;
selecting specific firing nozzles based on the fire pulse; and
applying the specific firing nozzles to the selected nozzle groups to fire the selected nozzles.

2. The method as claimed in claim 1, wherein the selecting of the simultaneous firing nozzles comprises:
storing in first memories the firing group data and direction data in synchronization with a shift clock;
storing outputs of the first memories in respective second memories in synchronization with a latch clock; and
ANDing respective outputs of the second memories and the fire pulse signal to generate nozzle firing signals.

3. The method as claimed in claim 2, wherein the selecting of the specific firing nozzles comprises:
ANDing the nozzle firing signals and the outputs of the nozzle group selection signals of the bi-directional shift register.

4. A device for transmitting serial data/addresses for a printer head in an interface unit transmitting firing information to the printer head with plural firing nozzles, comprising:
a data processing unit which provides:
input data comprising simultaneous firing nozzle data and data for determining a nozzle group firing direction, and
a fire pulse;
a firing group direction data line which provides the input data to the printer head;
a fire pulse line which provides the fire pulse to the printer head;
a selection unit which selects simultaneous firing nozzles based on the simultaneous firing nozzle data and the fire pulse;
a bi-directional shift register which generates firing nozzle group selection signals; and
a unit which fires the selected nozzles based on the firing nozzle group selection signals.

5. The device as claimed in claim 4, wherein the selection unit further comprises:
first memories which store the simultaneous firing nozzle data and the nozzle group firing direction data, the first memories having one more in number than a number of the simultaneous firing nozzles.

6. The device as claimed in claim 4, wherein the selection unit further comprises:
second memories which store the simultaneous firing nozzle data, the second memories having a same number as a number of the simultaneous firing nozzles.

7. The device as claimed in claim 6, wherein the selection unit further comprises:
a first plurality of logic AND gates, each of which logic-ANDs a portion of the simultaneous firing nozzle data and the fire pulse signal, a number of the logic and gates being the same as a number of the simultaneous firing nozzles.

8. The device as claimed in claim 7, wherein the selection unit further comprises:
a second plurality of logic AND gates, each of which logic ANDs an output of one of the plurality of first logic AND gates and one of the nozzle group selection signals of the bi-directional shift register, a number of the second plurality of logic AND gates being the same as a number of the nozzles of the printer head.

9. A device for generating signals for simultaneously firing nozzles of a printer head, the printer head comprising X groups of nozzles with Y nozzles in a group, where X and Y are integers, the device comprising:
a data processing unit which provides:
serial input data comprising Y bits which define specific nozzles of a group to be fired simultaneously and an additional bit,
a shift clock,
a latch clock, and
a fire pulse;
a converter which outputs the Y bits and the additional bit as parallel data in response to the shift clock;
a Y bit latch which latches the parallel Y bits in response to the latch clock;
a first logic AND unit which logic ANDs each of the parallel Y bits and the fire pulse, to output Y nozzle selection signals;
a bi-directional shift register having a shift direction input, X+2 parallel outputs comprising an MSB, an LSB and X outputs between the MSB and the LSB, wherein values of the X parallel outputs are shifted in response to the latch clock and the additional bit;
a second logic AND unit which logic ANDs each of the X outputs with each of the Y nozzle selection signals to output the simultaneous firing nozzle signals.

10. The device of claim 9, wherein:
the MSB and the LSB of the bi-directional shift are each initially preloaded with data of “1” prior to the values of the X parallel outputs being shifted.

11. The device of claim 9, wherein values of the X parallel outputs are shifted in a first direction where the additional bit has a value of 1 and are shifted in a second direction where the additional bit has a value of 0.

12. The device of claim 9, wherein the first logic AND unit comprises Y AND gates.

13. The device of claim 9, wherein the second logic unit comprises X*Y AND gates.

14. A method of generating simultaneous firing nozzle signals for a printer head, the printer head comprising X groups of nozzles with Y nozzles in a group, where X and Y are integers, the method comprising:
providing serial input data to the printer head, the serial input data comprising Y bits which define specific nozzles of a group to be fired simultaneously and an additional bit,
converting the Y bits and the additional bit to parallel data in response to a shift clock;
latching the parallel Y bits in response to a latch clock;
loading a predetermined value into a bi-directional shift register and outputting X bits in parallel;
shifting the value of the parallel outputs of the bi-directional shift register in response to the latch clock and the additional bit, a direction of the shift being controlled by the additional bit;
logically ANDing each of the Y bits with a fire pulse and with each of the X bits to output the simultaneous firing nozzle signals.

15. The method of claim 14, further comprising:
outputting the X bits and an MSB and an LSB from the bi-directional shift register, and
loading a 1 into each of the MSB and the LSB and loading a 0 into each of the X bits as the predetermined value.
